(19) United States
(12) Patent Application Publication
(10) Pub. No.: US 2011/0059323 A1
(43) Pub. Date: Mar. 10, 2011

(54) Alloy, high-temperature corrosion protection layer and layer system

(76) Inventors: Friedhelm Schmitz, Dinslaken (DE); Werner Stamm, Mulheim an der Ruhr (DE)

(21) Appl. No.: 12/920,591

(22) PCT Filed: Mar. 4, 2008
(86) PCT No.: PCT/EP2008/001722

§ 371 Date: Nov. 23, 2010

(51) Int. Cl. C22C 19/05; B32B 15/04

(52) U.S. Cl. 428/450; 420/442; 420/443

(57) ABSTRACT

A nickel-based protective layer which has a high percentage in chromium and optionally silicon and/or yttrium is provided. The nickel-based protective layer is used as low-temperature corrosion protective layer of nickel-or cobalt-based alloys. The alloy of which the layer is made and a layer system are also provided. The alloy may also include a refractory element such as hafnium or scandium.

### CROSS REFERENCE TO RELATED APPLICATIONS

This application is the US National Stage of International Application No. PCT/EP2008/001722, filed Mar. 4, 2008 and claims the benefit thereof.

### FIELD OF INVENTION

The invention relates to an alloy, a layer and a layer system having a protective effect against high-temperature corrosion.

### BACKGROUND OF INVENTION

Components in gas turbines are exposed to a corrosive gas, i.e. a gas having corrosive constituents. Examples of these constituents are alkali metals and sulfur from the fuel and/or the air. During the combustion process, these alkali metals and the sulfur are bound together to form alkali metal sulfates, and these in turn can lead to disintegration reactions of the protective metal oxides of the protective layer or of the base material in the hot-gas passage. This shortens the service life of the components.

A distinction is made between two types of attack: HTK1 and HTK2, which can respectively occur in higher (about 800° C. to 950° C.) or lower (600° C. to 800° C.) temperature ranges and underlie different mechanisms and manifestations.

HTK2 (low-temperature corrosion) is based on the fact that low-melting alloy metal sulfates of the cobalt and of the nickel are produced under specific boundary conditions (relatively high sulfur dioxide partial pressures) and lead to destruction of the material. It is assumed that higher partial pressures are needed for the formation of cobalt sulfates than for nickel sulfates, and this would support the use of cobalt-base protective layers or base materials.

Accordingly, cobalt-base base alloys with a high chromium content are known.

### SUMMARY OF INVENTION

However, nickel-based materials are often used for the components of gas turbines, and therefore there is a discrepancy between the base material of substrate and protective layer. It is therefore an object of the invention to solve this problem.

The object is achieved by means of an alloy as claimed in the claims, a layer as claimed in the claims and a layer system as claimed in the claims.

The dependent claims respectively list further advantageous measures which can be combined with one another, as desired, in order to obtain further advantages.

### BRIEF DESCRIPTION OF THE DRAWINGS

FIG. 1 shows a first exemplary embodiment,

FIG. 2 shows a second exemplary embodiment,

FIG. 3 shows a gas turbine,

FIG. 4 shows a perspective view of a turbine blade or vane,

FIG. 5 shows a perspective view of a combustion chamber, and

FIG. 6 shows a list of superalloys.

The figures and the description represent only exemplary embodiments of the invention.

### DETAILED DESCRIPTION OF INVENTION

The alloy is a nickel-based alloy and has a chromium content of 20% by weight to 45% by weight in order to form an effective protective layer of chromium oxide.

Optional limitations for chromium are 20% by weight-28% by weight, 28% by weight-36% by weight and 36% by weight-45% by weight, depending on the point of application and demand for protection against oxidation.

Silicon (Si) is likewise optionally present in an amount of 0.1% by weight to 3% by weight.

Further optional limitations for silicon are 0.1% by weight-1% by weight, 1% by weight-3% by weight and 2% by weight-3% by weight, depending on the demand for protection against oxidation.

The alloy preferably consists of nickel (Ni), chromium (Cr) and silicon (Si).

It is preferable for there to be no aluminum.

In order to improve the adhesion of the oxide layer, at least one refractory element such as yttrium (Y), hafnium (Hf), cerium (Ce) or scandium (Sc) is advantageously present in an amount of 0.3% by weight to 0.8% by weight.

It is preferable for no other refractory elements to be used. The alloy preferably consists of nickel (Ni), chromium (Cr), silicon (Si) and yttrium (Y).

The refractory elements have the additional effect of sulfur gettering. Sulfur is found in particular in fuels containing heavy oil, and therefore this layer 7 is preferably used for such fuels and a gas turbine 100 is operated therewith.

Preference is given to using only one refractory element, preferably yttrium (Y). The alloy preferably consists of nickel (Ni), chromium (Cr) and yttrium (Y).

It is preferable for there to be no cobalt (Co) in the alloy, and therefore no Ni—Co mixed phases are produced.

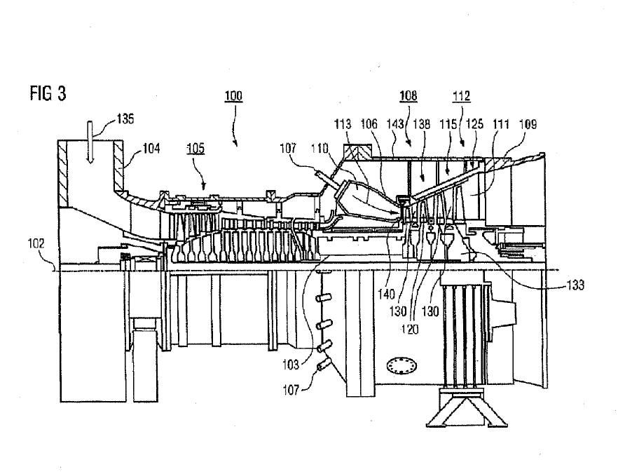

An alloy of this type can be applied to components 120, 130, 155 (FIGS. 3, 4, 5) by means of known processes, such as LPPS, VPS, APS, HVOF, flame spraying, cold spraying or EBPVD processes.

The layer thickness of the layer 7 in this case can preferably be 200 μm to 500 μm.

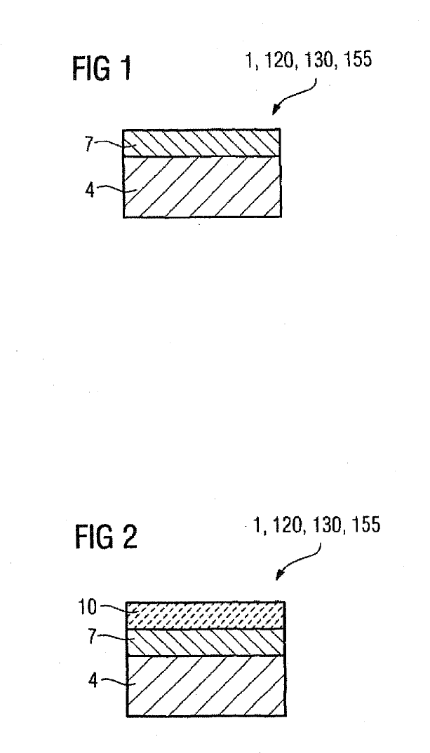

A protective layer 7 of this type can be used as overlay. It is likewise possible for a ceramic thermal barrier coating 10 (FIG. 1) to be present on the protective layer 7 (FIG. 1) made of this alloy.

One application example is as follows:

25% by weight-35% by weight chromium (Cr),

0.1% by weight-3% by weight silicon (Si),

0.2% by weight-0.8% by weight yttrium (Y), cerium (Ce), hafnium (Hf) or scandium (Sc), remainder nickel (Ni).

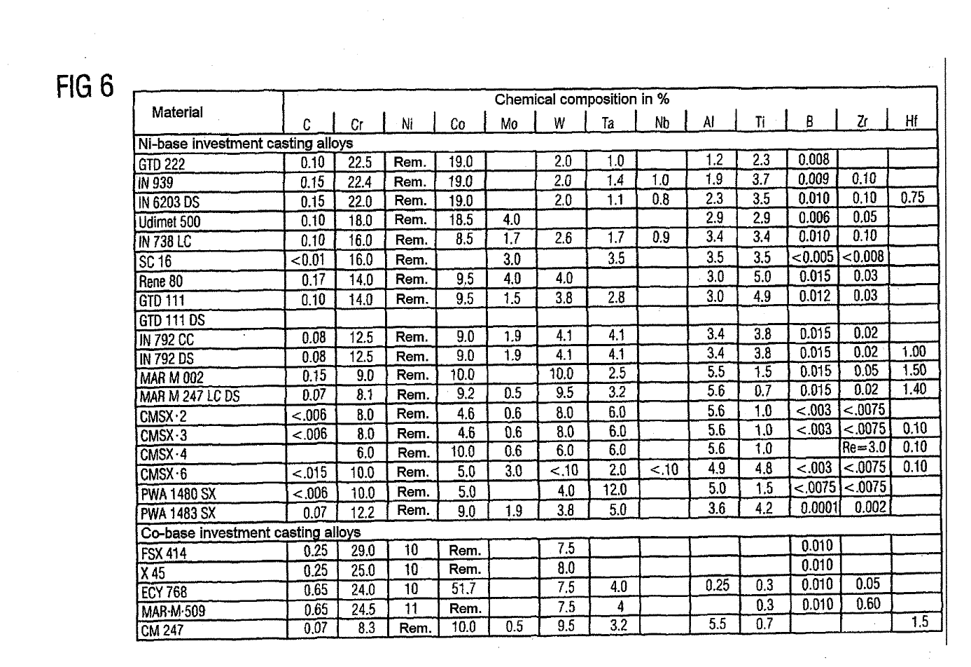

In FIG. 1, the component 1 has a substrate 4 made of a superalloy as shown in FIG. 6.

A protective layer 7 made of the alloy described above, preferably consisting thereof, is present on said substrate 4. The protective layer 7 is preferably the outermost layer.

Proceeding from FIG. 1, a ceramic thermal barrier coating 10 is present on the protective layer 7 in FIG. 2.

The ceramic coating 10 is preferably the outermost layer.

FIG. 3 shows, by way of example, a partial longitudinal section through a gas turbine 100.

In the interior, the gas turbine 100 has a rotor 103 with a shaft 101 which is mounted such that it can rotate about an axis of rotation 102 and is also referred to as the turbine rotor.

An intake housing 104, a compressor 105, a, for example, toroidal combustion chamber 110, in particular an annular combustion chamber, with a plurality of coaxially arranged burners 107, a turbine 108 and the exhaust-gas housing 109 follow one another along the rotor 103.

The annular combustion chamber 110 is in communication with a, for example, annular hot-gas passage 111, where, by way of example, four successive turbine stages 112 form the turbine 108.

Each turbine stage 112 is formed, for example, from two blade or vane rings. As seen in the direction of flow of a working medium 113, in the hot-gas passage 111 a row of guide vanes 115 is followed by a row 125 formed from rotor blades 120.

The guide vanes 130 are secured to an inner housing 138 of a stator 143, whereas the rotor blades 120 of a row 125 are fitted to the rotor 103 for example by means of a turbine disk 133.

A generator (not shown) is coupled to the rotor 103.

While the gas turbine 100 is operating, the compressor 105 sucks in air 135 through the intake housing 104 and compresses it. The compressed air provided at the turbine-side end of the compressor 105 is passed to the burners 107, where it is mixed with a fuel. The mix is then burnt in the combustion chamber 110, forming the working medium 113. From there, the working medium 113 flows along the hot-gas passage 111 past the guide vanes 130 and the rotor blades 120. The working medium 113 is expanded at the rotor blades 120, transferring its momentum, so that the rotor blades 120 drive the rotor 103 and the latter in turn drives the generator coupled to it.

While the gas turbine 100 is operating, the components which are exposed to the hot working medium 113 are subject to thermal stresses. The guide vanes 130 and rotor blades 120 of the first turbine stage 112, as seen in the direction of flow of the working medium 113, together with the heat shield elements which line the annular combustion chamber 110, are subject to the highest thermal stresses.

To be able to withstand the temperatures which prevail there, they may be cooled by means of a coolant.

Substrates of the components may likewise have a directional structure, i.e. they are in single-crystal form (SX structure) or have only longitudinally oriented grains (DS structure).

By way of example, iron-based, nickel-based or cobalt-based superalloys are used as material for the components, in particular for the turbine blade or vane 120, 130 and components of the combustion chamber 110.

Superalloys of this type are known, for example, from EP 1 204 776 B1, EP 1 306 454, EP 1 319 729 A1, WO 99/67435 or WO 00/44949.

The blades or vanes 120, 130 may likewise have coatings protecting against corrosion (MCrAlX; M is at least one element selected from the group consisting of iron (Fe), cobalt (Co), nickel (Ni), X is an active element and stands for yttrium (Y) and/or silicon, scandium (Sc) and/or at least one rare earth element, or hafnium). Alloys of this type are known from EP 0 486 489 B1, EP 0 786 017 B1, EP 0 412 397 B1 or EP 1 306 454 A1.

It is also possible for a thermal barrier coating to be present on the MCrAlX, consisting for example of ZrO₂, Y₂O₃—ZrO₂, i.e. unstabilized, partially stabilized or fully stabilized by yttrium oxide and/or calcium oxide and/or magnesium oxide.

Columnar grains are produced in the thermal barrier coating by suitable coating processes, such as for example electron beam physical vapor deposition (EB-PVD).

The guide vane 130 has a guide vane root (not shown here), which faces the inner housing 138 of the turbine 108, and a guide vane head which is at the opposite end from the guide vane root. The guide vane head faces the rotor 103 and is fixed to a securing ring 140 of the stator 143.

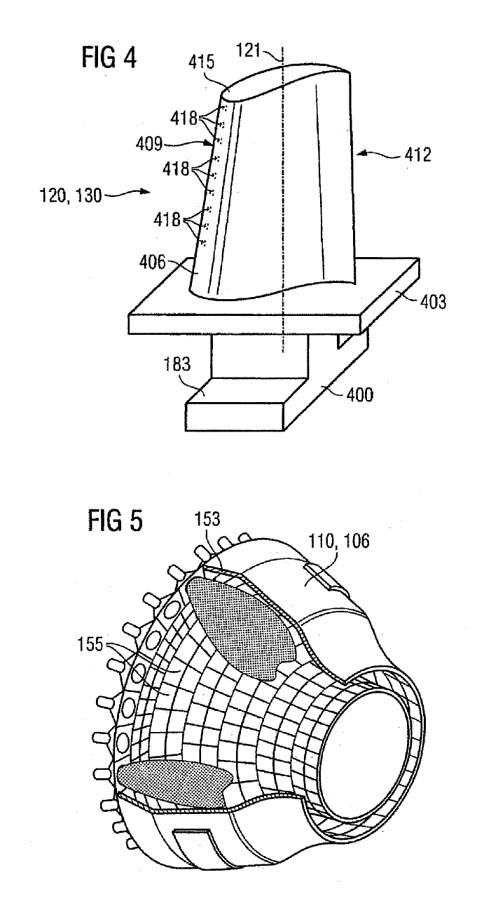

FIG. 4 shows a perspective view of a rotor blade 120 or guide vane 130 of a turbomachine, which extends along a longitudinal axis 121.

The turbomachine may be a gas turbine of an aircraft or of a power plant for generating electricity, a steam turbine or a compressor.

The blade or vane 120, 130 has, in succession along the longitudinal axis 121, a securing region 400, an adjoining blade or vane platform 403 and a main blade or vane part 406 and a blade or vane tip 415.

As a guide vane 130, the vane 130 may have a further platform (not shown) at its vane tip 415.

A blade or vane root 183, which is used to secure the rotor blades 120, 130 to a shaft or a disk (not shown), is formed in the securing region 400.

The blade or vane root 183 is designed, for example, in hammerhead form. Other configurations, such as a fir-tree or dovetail root, are possible.

The blade or vane 120, 130 has a leading edge 409 and a trailing edge 412 for a medium which flows past the main blade or vane part 406.

In the case of conventional blades or vanes 120, 130, by way of example solid metallic materials, in particular superalloys, are used in all regions 400, 403, 406 of the blade or vane 120, 130.

Superalloys of this type are known, for example, from EP 1 204 776 B1, EP 1 306 454, EP 1 319 729 A1, WO 99/67435 or WO 00/44949.

The blade or vane 120, 130 may in this case be produced by a casting process, by means of directional solidification, by a forging process, by a milling process or combinations thereof.

Workpieces with a single-crystal structure or structures are used as components for machines which, in operation, are exposed to high mechanical, thermal and/or chemical stresses.

Single-crystal workpieces of this type are produced, for example, by directional solidification from the melt. This involves casting processes in which the liquid metallic alloy solidifies to form the single-crystal structure, i.e. the single-crystal workpiece, or solidifies directionally.

In this case, dendritic crystals are oriented along the direction of heat flow and form either a columnar crystalline grain structure (i.e. grains which run over the entire length of the workpiece and are referred to here, in accordance with the language customarily used, as directionally solidified) or a single-crystal structure, i.e. the entire workpiece consists of one single crystal. In these processes, a transition to globular (polycrystalline) solidification needs to be avoided, since non-directional growth inevitably forms transverse and longitudinal grain boundaries, which negate the favorable properties of the directionally solidified or single-crystal component.

Where the text refers in general terms to directionally solidified microstructures, this is to be understood as meaning both single crystals, which do not have any grain boundaries or at most have small-angle grain boundaries, and columnar crystal structures, which do have grain boundaries running in the longitudinal direction but do not have any transverse grain boundaries. This second form of crystalline structures is also described as directionally solidified microstructures (directionally solidified structures).

Processes of this type are known from U.S. Pat. No. 6,024,792 and EP 0 892 090 A1.

The blades or vanes 120, 130 may likewise have coatings protecting against corrosion or oxidation e.g. (MCrAlX; M is at least one element selected from the group consisting of iron (Fe), cobalt (Co), nickel (Ni), X is an active element and stands for yttrium (Y) and/or silicon and/or at least one rare earth element, or hafnium (Hf)). Alloys of this type are known from EP 0 486 489 B1, EP 0 786 017 B1, EP 0 412 397 B1 or EP 1 306 454 A1, which are intended to form part of this disclosure with regard to the chemical composition of the alloy.

The density is preferably 95% of the theoretical density.

A protective aluminum oxide layer (TGO=thermally grown oxide layer) is formed on the MCrAlX layer (as an intermediate layer or as the outermost layer).

The layer preferably has a composition Co-30Ni-28Cr-8Al-0.6Y-0.7Si or Co-28Ni-24Cr-10Al-0.6Y. In addition to these cobalt-based protective coatings, it is also preferable to use nickel-based protective layers, such as Ni-10Cr-12Al-0.6Y-3Re or Ni-12Co-21Cr-11Al-0.4Y-2Re or Ni-25Co-17Cr-10Al-0.4Y-1.5Re.

It is also possible for a thermal barrier coating, which is preferably the outermost layer and consists for example of ZrO₂, Y₂O₃—ZrO₂, i.e. unstabilized, partially stabilized or fully stabilized by yttrium oxide and/or calcium oxide and/or magnesium oxide, to be present on the MCrAlX.

The thermal barrier coating covers the entire MCrAlX layer. Columnar grains are produced in the thermal barrier coating by suitable coating processes, such as for example electron beam physical vapor deposition (EB-PVD).

Other coating processes are possible, for example atmospheric plasma spraying (APS), LPPS, VPS or CVD. The thermal barrier coating may include grains that are porous or have micro-cracks or macro-cracks, in order to improve the resistance to thermal shocks. The thermal barrier coating is therefore preferably more porous than the MCrAlX layer.

Refurbishment means that after they have been used, protective layers may have to be removed from components 120, 130 (e.g. by sand-blasting). Then, the corrosion and/or oxidation layers and products are removed. If appropriate, cracks in the component 120, 130 are also repaired. This is followed by recoating of the component 120, 130, after which the component 120, 130 can be reused.

The blade or vane 120, 130 may be hollow or solid in form.

If the blade or vane 120, 130 is to be cooled, it is hollow and may also have film-cooling holes 418 (indicated by dashed lines).

FIG. 5 shows a combustion chamber 110 of a gas turbine.

The combustion chamber 110 is configured, for example, as what is known as an annular combustion chamber, in which a multiplicity of burners 107, which generate flames 156, arranged circumferentially around an axis of rotation 102 open out into a common combustion chamber space 154. For this purpose, the combustion chamber 110 overall is of annular configuration positioned around the axis of rotation 102.

To achieve a relatively high efficiency, the combustion chamber 110 is designed for a relatively high temperature of the working medium M of approximately 1000° C. to 1600° C. To allow a relatively long service life even with these operating parameters, which are unfavorable for the materials, the combustion chamber wall 153 is provided, on its side which faces the working medium M, with an inner lining formed from heat shield elements 155.

On the working medium side, each heat shield element 155 made from an alloy is equipped with a particularly heat-resistant protective layer (MCrAlX layer and/or ceramic coating) or is made from material that is able to withstand high temperatures (solid ceramic bricks).

These protective layers may be similar to the turbine blades or vanes, i.e. for example MCrAlX: M is at least one element selected from the group consisting of iron (Fe), cobalt (Co), nickel (Ni), X is an active element and stands for yttrium (Y) and/or silicon and/or at least one rare earth element or hafnium (Hf). Alloys of this type are known from EP 0 486 489 B1, EP 0 786 017 B1, EP 0 412 397 B1 or EP 1 306 454 A1.

It is also possible for a, for example, ceramic thermal barrier coating to be present on the MCrAlX, consisting for example of ZrO₂, Y₂O₃—ZrO₂, i.e. unstabilized, partially stabilized or fully stabilized by yttrium oxide and/or calcium oxide and/or magnesium oxide.

Columnar grains are produced in the thermal barrier coating by suitable coating processes, such as for example electron beam physical vapor deposition (EB-PVD).

Other coating processes are possible, e.g. atmospheric plasma spraying (APS), LPPS, VPS or CVD. The thermal barrier coating may include grains that are porous or have micro-cracks or macro-cracks, in order to improve the resistance to thermal shocks.

Refurbishment means that after they have been used, protective layers may have to be removed from heat shield elements 155 (e.g. by sand-blasting). Then, the corrosion and/or oxidation layers and products are removed. If appropriate, cracks in the heat shield element 155 are also repaired. This is followed by recoating of the heat shield elements 155, after which the heat shield elements 155 can be reused.

Moreover, a cooling system may be provided for the heat shield elements 155 and/or their holding elements, on account of the high temperatures in the interior of the combustion chamber 110. The heat shield elements 155 are then, for example, hollow and may also have cooling holes (not shown) opening out into the combustion chamber space 154.

1.-20. (canceled)

21. An alloy, comprising: (in % by weight)
20%-45% chromium; and
remainder nickel.

22. The alloy as claimed in claim 21, further comprising:
0.1%-3% silicon, and
0.2%-0.8% of an element selected from the group of refractory elements consisting of:
yttrium, hafnium, cerium, and scandium.

23. The alloy as claimed in claim 21, wherein the chromium content is 20% by weight to 28% by weight.

24. The alloy as claimed in claim 21, wherein the chromium content is 28% by weight to 36% by weight.

25. The alloy as claimed in claim 21, wherein the chromium content is 36% by weight to 45% by weight.

26. The alloy as claimed in claim 21, wherein the chromium content is 30% by weight to 35% by weight.

27. The alloy as claimed in claim 21, wherein the alloy comprises at least yttrium in a group of refractory elements.

28. The alloy as claimed in claim 22, wherein the refractory element is only yttrium.

29. The alloy as claimed in claim 22,
wherein the alloy comprises at least silicon, and
wherein the silicon content is at least 0.1%.

30. The alloy as claimed in 21, wherein the alloy consists of nickel and chromium.

31. The alloy as claimed in claim 21, wherein the alloy consists of nickel, chromium and silicon.

32. The alloy as claimed in claim 21, wherein the alloy, consists of nickel, chromium, and yttrium.

33. The alloy as claimed in claim 22, wherein the alloy consists of nickel, chromium, silicon and yttrium.

34. The alloy as claimed in claim 21, wherein the alloy consists of nickel, chromium, silicon and an element from the group consisting of yttrium, hafnium, cerium and scandium.

35. The alloy as claimed in claim 21, wherein the alloy consists of nickel, chromium and an element from the group consisting of yttrium, hafnium, cerium and scandium.

36. A layer, comprising:
an alloy, comprising (in a wt %):
20%-45% chromium, and
remainder nickel.

37. The layer as claimed in claim 36,
consisting of an alloy, comprising:
20%-45% chromium, and
remainder nickel.

38. A layer system, comprising:
a substrate; and
a layer, comprising:
an alloy, comprising:
20%-45% chromium, and
remainder nickel.

39. The layer system as claimed in claim 38, wherein the layer system includes an outer ceramic coating on the layer.

40. The layer system as claimed in claim 38, wherein the layer is an outermost layer in the layer system.
